(19) United States
(12) Patent Application Publication
(10) Pub. No.: US 2012/0122512 A1
(43) Pub. Date: May 17, 2012

(54) CELLULAR NETWORK, BASE STATION AND METHOD FOR SELF-OPTIMIZING TRANSMIT POWER TO USER EQUIPMENTS

(76) Inventors: Sairamesh Nammi, Dallas, TX (US); Narendra Tilwani, Addison, TX (US)

(21) Appl. No.: 12/948,202

(22) Filed: Nov. 17, 2010

(51) Int. Cl. H04B 7/00

(52) U.S. Cl. 455/522

(57) ABSTRACT

A base station and a method are described herein for self-optimizing the transmit power to user equipments (UEs) within a cell of a cellular network. In addition, a cellular network is described herein that includes multiple base stations (e.g., base transmitter stations, eNodeBs) each of which is configured to self-optimize the transmit power to the UEs within their respective cell.

### TECHNICAL FIELD

The present invention relates to a base station and a method for self-optimizing the transmit power to user equipments (UEs) within a cell of a cellular network. In addition, the present invention relates to a cellular network that includes multiple base stations each of which is configured to self-optimize the transmit power to the UEs within their respective cell.

### BACKGROUND

Manufacturers of equipment used in cellular networks are constantly trying to enhance their equipment to improve the operating expense (OPEX) of the service operator and/or improve the service (e.g., throughput) for the UEs. One way that a base station (e.g., base transmitter station, eNodeB) can be enhanced to improve the OPEX of the service operator and/or improve the service (e.g., throughput) for the UEs is the subject of the present invention.

### SUMMARY

A base station, a method, and a cellular network have been described in the independent claims of the present application. Advantageous embodiments of the base station, the method, and the cellular network have been described in the associated dependent claims.

In an aspect, the present invention provides a base station for self-optimizing a transmit power to a plurality of UEs within a cell of a cellular network. The base station comprises: (1) a power amplifier; (2) a processor; and (3) a non-transitory memory that stores processor-executable instructions wherein the processor interfaces with the non-transitory memory and executes the processor-executable instructions to: (a) determine the system load ‘SL’ as a function of a service cell load and at least one neighbor cell load, where the service cell load is a load within the cell and the at least one neighbor cell load is a load within at least one neighboring cell which is adjacent to the cell; (b) compare the system load ‘SL’ to the predetermined system load threshold ‘X’; (c) if the system load ‘SL’ is greater than the predetermined system load threshold ‘X’, then reduce a transmit power of the power amplifier to a minimum value; (d) if the system load ‘SL’ is less than the predetermined system load threshold ‘X’, then determine a percentage of the plurality of UEs within the cell that are considered cell edge users; (e) compare the percentage of the cell edge users to the predetermined cell edge user threshold ‘Y’; (f) if the percentage of the cell edge users is less than the predetermined cell edge user threshold ‘Y’, then increase the transmit power of the power amplifier; and (g) if the percentage of the cell edge users is greater than the predetermined cell edge user threshold ‘Y’, then maintain the transmit power of the power amplifier. The base station has the following advantages: (1) in interference limited conditions when the system load ‘SL’ is greater than the predetermined system load threshold ‘X’, then the OPEX will be improved for a service operator without any sector/user data throughput impact; and (2) in noise limited conditions when the percentage of the cell edge users is less than the predetermined cell edge user threshold ‘Y’, then the sector/user data throughput can be improved without any OPEX change.

In another aspect, the present invention provides a method implemented by a base station for self-optimizing a transmit power to a plurality of UEs within a cell of a cellular network. The method comprises the steps of: (1) determining a system load ‘SL’ as a function of a service cell load and at least one neighbor cell load, where the service cell load is a load within the cell and the at least one neighbor cell load is a load within at least one neighboring cell which is adjacent to the cell; (2) comparing the system load ‘SL’ to a predetermined system load threshold ‘X’; (3) if the system load ‘SL’ is greater than the predetermined system load threshold ‘X’, then reducing the transmit power to a minimum value; (4) if the system load ‘SL’ is less than the predetermined system load threshold ‘X’, then determining a percentage of the plurality of UEs within the cell that are considered cell edge users; (5) comparing the percentage of the cell edge users to a predetermined cell edge user threshold ‘Y’; (6) if the percentage of the cell edge users is less than the predetermined cell edge user threshold ‘Y’, then increasing the transmit power; and (7) if the percentage of the cell edge users is greater than the predetermined cell edge user threshold ‘Y’, then maintaining the transmit power. The advantages of this method are two-fold: (1) in interference limited conditions when the system load ‘SL’ is greater than the predetermined system load threshold ‘X’, then the OPEX will be improved for a service operator without any sector/user data throughput impact; and (2) in noise limited conditions when the percentage of the cell edge users is less than the predetermined cell edge user threshold ‘Y’, then the sector/user data throughput can be improved without any OPEX change.

In yet another aspect, the present invention provides a cellular network that comprises multiple base stations where each base station is associated with a cell and adapted to self-optimize a transmit power to UEs within the cell by: (1) determining a system load ‘SL’ as a function of a service cell load and at least one neighbor cell load, where the service cell load is a load within the cell and the at least one neighbor cell load is a load within at least one neighboring cell which is adjacent to the cell; (2) comparing the system load ‘SL’ to a predetermined system load threshold ‘X’; (3) if the system load ‘SL’ is greater than the predetermined system load threshold ‘X’, then reducing the transmit power to a minimum value; (4) if the system load ‘SL’ is less than the predetermined system load threshold ‘X’, then determining a percentage of the plurality of UEs within the cell that are considered cell edge users; (5) comparing the percentage of the cell edge users to a predetermined cell edge user threshold ‘Y’; (6) if the percentage of the cell edge users is less than the predetermined cell edge user threshold ‘Y’, then increasing the transmit power; and (7) if the percentage of the cell edge users is greater than the predetermined cell edge user threshold ‘Y’, then maintaining the transmit power. The advantages of this cellular network are two-fold: (1) in interference limited conditions when the system load ‘SL’ is greater than the predetermined system load threshold ‘X’, then the OPEX will be improved for a service operator without any sector/user data throughput impact; and (2) in noise limited conditions when the percentage of the cell edge users is less than the predetermined cell edge user threshold ‘Y’, then the sector/user data throughput can be improved without any OPEX change.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings:

FIG. 1 is a flowchart illustrating the steps of a method implemented by a base station for self-optimizing a transmit power to the UEs within a cell of a cellular network in accordance with an embodiment of the present invention;

FIG. 2 is a block diagram of an exemplary centralized cellular network that includes a core which is coupled to a base station controller that is coupled to multiple base stations each of which is configured to self-optimize the transmit power to the UEs within their respective cells in accordance with an embodiment of the present invention; and

FIG. 3 is a block diagram of an exemplary distributed cellular network that includes a core which is coupled to multiple base stations each of which is configured to self-optimize the transmit power to the UEs within their respective cells in accordance with an embodiment of the present invention.

### DETAILED DESCRIPTION

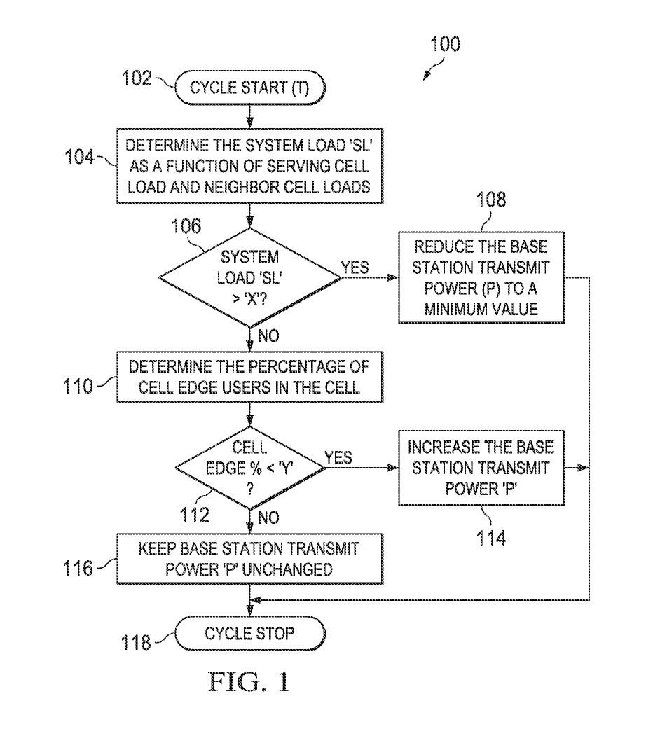

In a cellular network, it is a common practice today to set the transmit power of a base station to a fixed value. For example, the current Code Division Multiple Access (CDMA)/Global System for Mobile communications (GSM)/Wideband Code Division Multiple Access WCDMA/High-Speed Downlink Packet Access (HSDPA)/Evolution-Data Optimized (EV-DO) networks have base stations with 20 W power amplifiers. The current Long Term Evolution (LTE) networks have base stations with 40 W power amplifiers. The inventors have investigated the effects that a base station's transmit power has on the user throughput in a corresponding cell. During this investigation, the inventors observed that for a fully loaded network (interference limited system) the effect a base station's transmit power has on the user throughput is very minimal. The inventors then determined that this effect was due to the constant signal-to-interference and noise ratio (SINR) in the interference limited system. Thus, the inventors realized that there is no change in the system performance if the base station's transmit power is reduced to a minimum value. On the other hand, the inventors also observed that for a less loaded network (noise limited system) the user throughput can be increased by increasing the base station's transmit power. In view of the results from this investigation, the inventors have developed a method for determining system loading and using the system loading information to modify the base station's transmit power. This method and two exemplary base stations that can implement the method are discussed in detail below with respect to FIGS. 1-3.

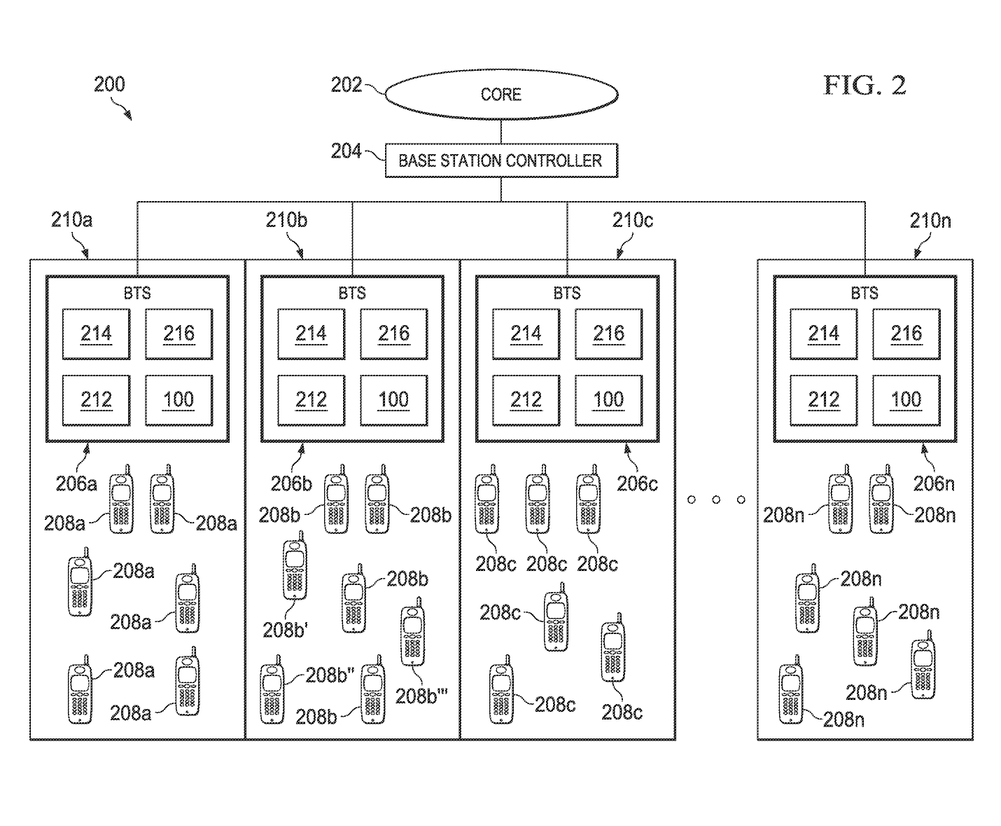

Referring to FIG. 1, there is a flowchart illustrating the steps of a method 100 implemented by a base station for self-optimizing a transmit power to the UEs within a cell of a cellular network in accordance with an embodiment of the present invention. Beginning at step 102, the base station starts the cycle which has a periodic time ‘T’ during which the base station determines system load ‘SL’ that it sees and subsequently uses to update its transmit power. At step 104, the base station determines the system load ‘SL’ which is a function of a service cell load and at least one neighbor cell load, where the service cell load is a load within the cell and the at least one neighbor cell load is a load within at least one neighboring cell which is adjacent to the cell. For instance, the base station can determine the service cell load as a function of one or more of the following: (1) total interference level in the cell; (2) total power utilization of the power amplifier; (3) traffic channel utilization; (4) total number of simultaneous connections to the UEs; and (5) other base station hardware or software resources. The base station can receive the neighbor cell load(s) from a base station controller that is connected to the neighboring base station(s) (see FIG. 2). Alternatively, the base station can receive the neighbor cell load(s) directly from the neighboring base station(s) (see FIG. 2).

At step 106, the base station compares the system load ‘SL’ to a predetermined system load threshold ‘X’. If the system load ‘SL’ is greater than the predetermined system load threshold ‘X’, then the base station at step 108 reduces the transmit power ‘P’ to a minimum value. In this case, the cellular network is a fully loaded network (interference limited system) and as such there will be no change or only a minimal change in the system's throughput performance if the base station's transmit power “P” is reduced to a minimum value. For instance, the minimum value can be determined by simulations or trials. If the system load ‘SL’ is less than the predetermined system load threshold ‘X’, then the base station at step 110 determines what percentage of the UEs within the cell are considered cell edge users. For instance, the base station can determine the percentage of cell edge users by comparing how many UEs are active in the cell to how many of those UEs are located next to the edge of the cell.

At step 112, the base station compares the percentage of cell edge users to a predetermined cell edge user threshold ‘Y’. If the percentage of the cell edge users is less than the predetermined cell edge user threshold ‘Y’, then the base station at step 114 increases the transmit power ‘P’. In this case, the cellular network is a less loaded network (noise limited system) and the user throughput can be increased by increasing the base station's transmit power ‘P’. The user throughput is defined to be number of successful received bits per second. If the percentage of the cell edge users is greater than the predetermined cell edge user threshold ‘Y’, then the base station at step 116 maintains the transmit power ‘P’. After steps 108, 114, and 116 and at the end of the periodic time period ‘T’, the base station at step 118 stops the cycle and then starts a new cycle by returning to step 102.

Referring to FIG. 2, there is an exemplary centralized cellular network 200 including a core 202 which is coupled to a base station controller 204 that is coupled to multiple base stations 206a, 206b, 206c . . . 206n each of which implement method 100 to self-optimize the transmit power to the UEs 208a, 208b, 208c . . . 208n within their respective cells 210a, 210b, 210c . . . 210n. Examples of a centralized cellular network 200 which can incorporate the enhanced base stations 206a, 206b, 206c . . . 206n of the present invention include a CDMA cellular network, an EV-DO cellular network, a Universal Mobile Telecommunications System (UMTS) cellular network, a WCDMA cellular network, and a HSDPA cellular network. One skilled in the art will readily appreciate that the cellular network 200, the core 202, the base station controller 204, the base stations 206a., 206b, 206c . . . 206n, and the UEs 208a, 208b, 208c . . . 208n incorporate many well-known components however descriptions about those well-known components have been omitted herein so as not to obscure the description related to the present invention. Furthermore, one skilled in the art will appreciate that the detailed description provided below about the base stations 206a, 206b, 206c . . . 206n readily teaches and enables the present invention. In this regard, only one base station 206b (for example) is described below to explain how it can be configured to operate and self-optimize the transmit power to the UEs 208b within cell 210b but it should be appreciated that the remaining base stations 206a, 206c . . . 206n would be configured to operate in a similar manner to self-optimize the transmit power to the UEs 208a, 208c . . . 208n within their respective cells 210a, 208c . . . 208n.

The base station 206b (e.g., base transmitter station 206b) includes a power amplifier 212, a processor 214, and a non-transitory memory 216 that stores processor-executable instructions where the processor 214 interfaces with the non-transitory memory 216 and implements method 100 by executing the processor-executable instructions to: (1) determine the system load ‘SL’ as a function of a service cell load and at least one neighbor cell load, where the service cell load is a load within the cell 210b and the at least one neighbor cell load is a load within at least one neighboring cell 210a and 210c (see step 104); (2) compare system load ‘SL’ to the predetermined system load threshold ‘X’ (step 106); (3) if the system load ‘SL’ is greater than the predetermined system load threshold ‘X’, then reduce a transmit power ‘P’ of the power amplifier 212 to a minimum value (step 108); (4) if the system load ‘SL’ is less than the predetermined system load threshold ‘X’, then determine a percentage of the plurality UEs 208b within the cell 210b that are considered cell edge users 208b′, 208b″ and 208b′″ (step 110); (5) compare the percentage of the cell edge users 208b′, 208b″ and 208b′″ to the predetermined cell edge user threshold ‘Y’ (step 112); (6) if the percentage of the cell edge users 208b′, 208b″ and 208b′″ is less than the predetermined cell edge user threshold ‘Y’, then increase the transmit power of the power amplifier 212 (step 114); and if the percentage of the cell edge users 208b′, 208b″ and 208b′″ is greater than the predetermined cell edge user threshold ‘Y’, then maintain the transmit power of the power amplifier 212 (step 116). The base station 206b implementing this method 100 has the following advantages: (1) in interference limited conditions when the system load ‘SL’ is greater than the predetermined system load threshold ‘X’, then the OPEX will be improved for a service operator without any sector/user data throughput impact; and (2) in noise limited conditions when the percentage of the cell edge users is less than the predetermined cell edge user threshold ‘Y’, then the sector/user data throughput can be improved without any OPEX change.

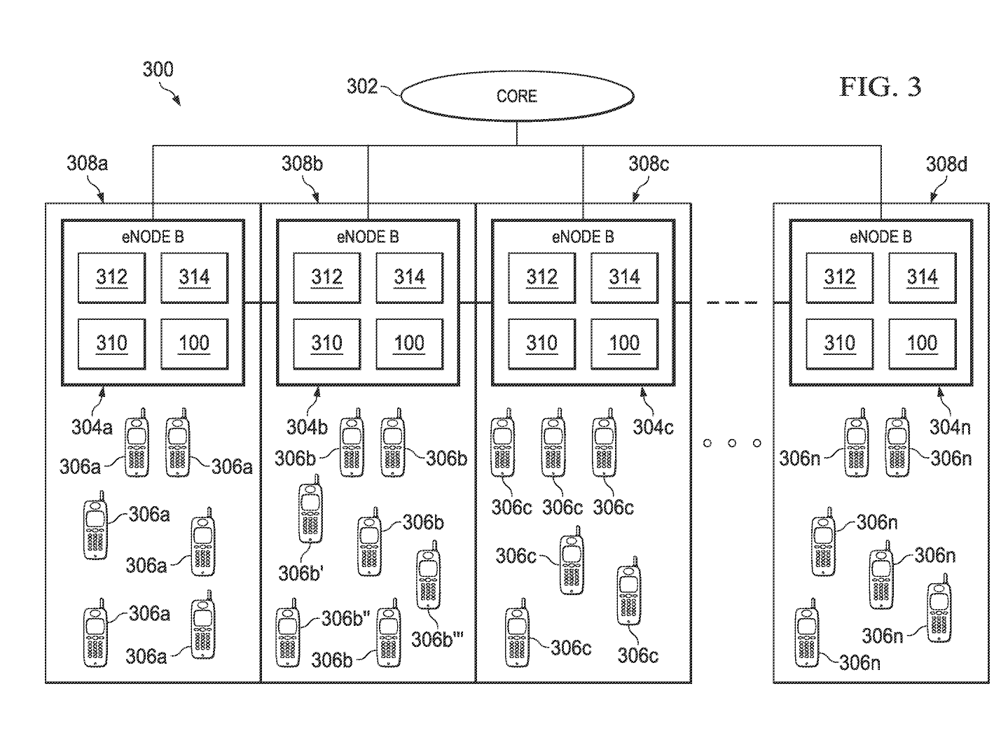

Referring to FIG. 3, there is an exemplary distributed cellular network 300 including a core 302 which is coupled to multiple base stations 304a, 304b, 304c . . . 304n each of which implements method 100 to self-optimize the transmit power to the UEs 306a, 306b, 306c . . . 306n within their respective cells 308a, 308b, 308c . . . 308n. Examples of a centralized cellular network 300 which can incorporate the enhanced base stations 304a, 304b, 304c . . . 304n of the present invention include a UTE cellular network, a LTE-A cellular network, and a Worldwide Interoperability for Microwave Access (WI-MAX) cellular network. One skilled in the art will readily appreciate that the cellular network 300, the core 302, the base stations 304a, 304b, 304c . . . 304n, and the UEs 306a, 306b, 306c . . . 306n incorporate many well-known components however descriptions about those well-known components have been omitted herein so as not to obscure the description related to the present invention. Furthermore, one skilled in the art wilt appreciate that the detailed description provided below about the base stations 304a, 304b, 304c . . . 304n readily teaches and enables the present invention. In this regard, only one base station 304b (for example) is described below to explain how it can be configured to operate and self-optimize the transmit power to the UEs 306b within cell 308b but it should be appreciated that the remaining base stations 304a, 304c . . . 304n would be configured to operate in a similar manner to self-optimize the transmit power to the UEs 306a, 306c . . . 306n within their respective cells 308a, 308c . . . 308n.

The base station 304b (e.g., eNodeB 304b) includes a power amplifier 310, a processor 312, and a non-transitory memory 314 that stores processor-executable instructions where the processor 312 interfaces with the non-transitory memory 314 and implements method 100 by executing the processor-executable instructions to: (1) determine the system load ‘SL’ as a function of a service cell load and at least one neighbor cell load, where the service cell load is a load within the cell 308b and the at least one neighbor cell load is a loud within at least one neighboring cell 308a and 308c (see step 104); (2) compare the system load ‘SL’ to the predetermined system load threshold ‘X’ (step 106); (3) if the system load ‘SL’ is greater than the predetermined system load threshold ‘X’, then reduce a transmit power ‘P’ of the power amplifier 310 to a minimum value (step 108); (4) if the system load ‘SL’ is less than the predetermined system load threshold ‘X’, then determine a percentage of the plurality of UEs 306b within the cell 308b that are considered cell edge users 306b′, 306b″ and 306b′″ (step 110); (5) compare the percentage of the cell edge users 306b′, 306b″ and 306b′″ to the predetermined cell edge user threshold ‘Y’ (step 112); (6) if the percentage of the cell edge users 306b′, 306b″ and 306b′″ is less than the predetermined cell edge user threshold ‘Y’, then increase the transmit power of the power amplifier 310 (step 114); and if the percentage of the cell edge users 306b′, 306b″ and 306b′″ is greater than the predetermined cell edge user threshold ‘Y’, then maintain the transmit power of the power amplifier 310 (step 116). The base station 304b by implementing method 100 has the following advantages: (1) in interference limited conditions when the system load ‘SL’; is greater than the predetermined system load threshold ‘X’, then the OPEX will be improved for a service operator without any sector/user data throughput impact; and (2) in noise limited conditions when the percentage of the cell edge users is less than the predetermined cell edge user threshold ‘Y’, then the sector/user data throughput can be improved without any OPEX change.

From the foregoing, one skilled in the art will appreciate that the present invention includes different types of base stations 206a, 206b, 206c . . . 206n, 304a, 304b, 304c . . . 304n and a method 100 for self-optimizing the transmit power to UEs 208a, 208b, 208c . . . 208n, 306a, 306b, 306c . . . 306n within cells 210a, 210b, 210c . . . 210n, 308a, 308b, 308c . . . 308n of a cellular network 200 and 300. The method 100 is rather simple to implement and does not require any standards change. The method 100 can be described as follows: Let ‘T’ denote a periodic time at which the base station determines system/network load ‘SL’ that it sees. Let ‘X’ and ‘Y’ are a predetermined values representing the system load threshold and the cell edge user threshold. Let ‘P’ be the default transmit power. Then, the base station 206b (for example) updates its transmit power for every time interval ‘T’ as follows:
1. Determine the system load ‘SL’.
2. If ‘SL’>‘X’, then reduce transmit power ‘P’ to minimum value and cycle stops.
3. If ‘SL’<‘X’, then determine percentage of cell edge users in the base station's cell 210b.
4. If the Cell Edge user %<‘Y’, then increase the base station transmit power ‘P’ and cycle stops.
5. If the Cell Edge user %>‘Y’, then keep the base station transmit power ‘P’ unchanged.

The method 100 is particularly well suited to be implemented by base stations 304a, 304b, 304c . . . 304n within Orthogonal Frequency-Division Multiplexing Access (OFDMA) systems such as the exemplary distributed cellular network 300 in which the frequency reuse factor is one and where they do not use any code to distinguish the base station's traffic signals. In particular, for OFDMA systems (e.g., LIE, WI-MAX) it is possible to use the same frequency band across the whole deployment. This would mean that frequency reuse is equal to one and as such one skilled in the art will then appreciate that the signal transmission in any sector/cell causes interference to its neighboring cells. Since OFDMA system do not use sector/cell specific PN codes to scramble its transmission signal, the signal strength is only a function of path loss and hence causes high interference to UEs of neighboring cells. Conversely, CDMA systems the PN code scrambling minimizes this interference. Hence, the present invention is more suitable to OFDMA systems. However, the present invention can be implemented in any system which has adaptive, modulation and coding such as the High Speed Packet Access (HSPA), LTE-A, EV-DO, Wi-Max, Wi-Fi etc. . . . .

Although multiple embodiments of the present invention have been illustrated in the accompanying Drawings and described in the foregoing Detailed Description, it should be understood that the invention is not limited to the disclosed embodiments, but instead is also capable of numerous rearrangements, modifications and substitutions without departing from the present invention that as has been set forth and defined within the following claims.

1. A base station for self-optimizing a transmit power to a plurality of user equipments, UEs, within a cell of a cellular network, the base station comprising:
a power amplifier;
a processor; and
a non-transitory memory that stores processor-executable instructions wherein the processor interfaces with the non-transitory memory and executes the processor-executable instructions to:
determine a system load as a function of a service cell load and at least one neighbor cell load, where the service cell load is a load within the cell and the at least one neighbor cell load is a load within at least one neighboring cell which is adjacent to the cell;
compare the system load to a predetermined system load threshold;
if the system load is greater than the predetermined system load threshold, then reduce a transmit power of the power amplifier to a minimum value;
if the system load is less than the predetermined system load threshold, then determine a percentage of the plurality of UEs within the cell that are considered cell edge users;
compare the percentage of the cell edge users to a predetermined cell edge user threshold;
if the percentage of the cell edge users is less than the predetermined cell edge user threshold, then increase the transmit power of the power amplifier; and
if the percentage of the cell edge users is greater than the predetermined cell edge user threshold, then maintain the transmit power of the power amplifier.

2. The base station of claim 1, wherein the processor further executes the processor-executable instructions to determine the service cell load as a function of at least one of the following:
total interference level in the cell;
total power utilization of the power amplifier;
traffic channel utilization;
total number of simultaneous connections to the UEs; and
other base station hardware or software resources.

3. The base station of claim 1, wherein the processor further executes the processor-executable instructions to determine the at least one neighbor cell load by receiving the at least one neighbor cell load from at least one neighboring base station.

4. The base station of claim 1, wherein the processor further executes the processor-executable instructions to determine the at least one neighbor cell load by receiving the at least one neighbor cell load from a base station controller.

5. A method implemented by a base station for self-optimizing a transmit power to a plurality of user equipments, UEs, within a cell of a cellular network, the method comprises the steps of:
determining a system load as a function of a service cell load and at least one neighbor cell load, where the service cell load is a load within the cell and the at least one neighbor cell load is a load within at least one neighboring cell which is adjacent to the cell;
comparing the system load to a predetermined system load threshold;
if the system load is greater than the predetermined system load threshold, then reducing the transmit power to a minimum value;
if the system load is less than the predetermined system load threshold, then determining a percentage of the plurality of UEs within the cell that are considered cell edge users;
comparing the percentage of the cell edge users to a predetermined cell edge user threshold;
if the percentage of the cell edge users is less than the predetermined cell edge user threshold, then increasing the transmit power; and
if the percentage of the cell edge users is greater than the predetermined cell edge user threshold, then maintaining the transmit power.

6. The method of claim 5, wherein the service cell load is determined as a function of at least one of the following:
total interference level in the cell;
total power utilization of the power amplifier;
traffic channel utilization;
total number of simultaneous connections to the UEs; and
other base station hardware or software resources.

7. The method of claim 5, wherein the step of determining the at least one neighbor cell load includes receiving the at least one neighbor cell load from at least one neighboring base station.

8. The method of claim 5, wherein the step of determining the at least one neighbor cell load includes receiving the at least one neighboring cell load from a base station controller.

9. A cellular network comprising:
a plurality of base stations, each base station is associated with a cell and adapted to self-optimize a transmit power to a plurality of user equipments, UEs, within the associated cell by:
determining a system load as a function of a service cell load and at least one neighbor cell load, where the service cell load is a load within the cell and the at least on neighbor cell load is a load within at least one neighboring cell which is adjacent to the cell;
comparing the system load to a predetermined system load threshold;
if the system load is greater than the predetermined system load threshold, then reducing the transmit power to a minimum value;
if the system load is less than the predetermined system load threshold, then determining a percentage of the plurality of UEs within the cell that are considered cell edge users;
comparing the percentage of the cell edge users to a predetermined cell edge user threshold;
if the percentage of the cell edge users is less than the predetermined cell edge user threshold, then increasing the transmit power; and
if the percentage of the cell edge users is greater than the predetermined cell edge user threshold, then maintaining the transmit power.

10. The cellular network of claim 9, wherein each base station determines the service cell load as a function of at least one of the following:
total interference level in the cell;
total power utilization of the power amplifier;
traffic channel utilization;
total number of simultaneous connections to the UEs; and
other base station hardware or software resources.

11. The cellular network of claim 9, wherein each base station determines the at least one neighbor cell load by receiving the at least one neighbor cell load from at least one neighboring base station.

12. The cellular network of claim 9, wherein each base station determines the at least one neighbor cell load by receiving the at least one neighbor cell load from a base station controller.

13. The cellular network of claim 9, wherein each base station is a base transmitter station.

14. The cellular network of claim 9, wherein each base station is an eNodeB.

15. The cellular network of claim 9, wherein the cellular network is an Orthogonal Frequency-Division Multiplexing, OFDM, cellular network.

16. The cellular network of claim 9, where the cellular network implements an adaptive modulation and coding scheme.
